(19) United States
(12) Patent Application Publication
(10) Pub. No.: US 2026/0301574 A1
(43) Pub. Date: Oct. 1, 2026

(54) NOTIFICATION SYSTEM, NOTIFICATION METHOD, NOTIFICATION DEVICE, AND STORAGE MEDIUM

(71) Applicant: HONDA MOTOR CO., LTD., Tokyo (JP)

(72) Inventor: Tomoaki Nakayama, Wako-shi (JP)

(21) Appl. No.: 19/453,248

(22) Filed: Jan. 20, 2026

(30) Foreign Application Priority Data
Mar. 28, 2025 (JP) 2025-056513

(51) Int. Cl. G08G 1/16; G06V 40/16; G10L 25/63

(52) U.S. Cl. CPC G08G 1/164; G06V 40/174; G08G 1/166; G10L 25/63

(57) ABSTRACT

A notification system includes: a notification device used by a user outside a moving body and provided with a notification device main body, and a processor, wherein the processor gives a notification from the notification device when a first situation including a situation of the user using the notification device and a situation of the notification device main body satisfies a first notification condition, gives a notification from the moving body when a second situation including a situation of the user using the moving body and a situation of the moving body satisfies a second notification condition, and when the first situation satisfies the first notification condition, gives a notification by a notification mode based on link information in which the first notification condition, the second notification condition, and the notification mode are linked.

### INCORPORATION BY REFERENCE

The present application claims priority under 35 U.S.C. § 119 to Japanese Patent Application No. 2025-056513 filed on Mar. 28, 2025. The content of the application is incorporated herein by reference in its entirety.

### BACKGROUND OF THE INVENTION

### Field of the Invention

The present invention relates to a notification system, a notification method, a notification device, and a storage medium.

### Description of the Related Art

A technology is known in which information regarding a user is acquired in a device utilized outside a moving body and the information regarding the user is reflected in control in the moving body. For example, Japanese Patent No. 4371057 discloses an agent system that utilizes information obtained outside a vehicle and gives a recommendation appropriate for a user by reflecting user information stored in a portable terminal device in an agent device inside the vehicle.

A degree of reaction to a notification in a moving body is different depending on users. Japanese Patent No. 4371057 is configured to give a notification by utilizing information regarding a user so that it can be said that there is a possibility that the user reacts to the notification in a vehicle. However, a situation in a moving body and a situation of a device utilized outside the moving body do not always coincide. Therefore, in a configuration of giving a notification without considering each situation as in Japanese Patent No. 4371057, a user may not react to a notification from a moving body, and there is room to further improve a degree of user's reaction to a notification in a moving body.

The present invention is implemented in consideration of circumstances described above, and an object thereof is to be able to improve a degree of user's reaction to a notification in a moving body.

### SUMMARY OF THE INVENTION

One aspect of the present invention is a notification system including: a notification device used by a user outside a moving body and provided with a notification device main body; a first notification unit configured to give a notification from the notification device when a first situation including a situation of the user using the notification device and a situation of the notification device main body satisfies a first notification condition; and a second notification unit configured to give a notification from the moving body when a second situation including a situation of the user using the moving body and a situation of the moving body satisfies a second notification condition, and the first notification unit, when the first situation satisfies the first notification condition, gives a notification by a notification mode of the second notification unit based on link information in which the first notification condition, the second notification condition, and the notification mode of the second notification unit are linked.

According to one aspect of the present invention, a degree of user's reaction to a notification in a moving body can be improved.

### BRIEF DESCRIPTION OF THE DRAWINGS

FIG. 1 is a diagram illustrating a configuration of a notification system;

FIG. 2 is a diagram illustrating a configuration of a control system of a second controller of a moving body;

FIG. 3 is a diagram for describing a first notification condition and a first notification mode;

FIG. 4 is a diagram for describing a second notification condition and a second notification mode;

FIG. 5 is a diagram for describing link information;

FIG. 6 is a diagram illustrating a configuration of a control system of a first controller of a notification device;

FIG. 7 is a diagram illustrating a configuration of a control system of a server controller of a server;

FIG. 8 is a flowchart illustrating operations of the server, the notification device, and the moving body;

FIG. 9 is a flowchart illustrating an operation of a communication device;

FIG. 10 is a flowchart illustrating an operation of the second controller of the moving body;

FIG. 11 is a schematic diagram describing a utilization example of the notification system; and

FIG. 12 is a flowchart illustrating an operation of the server.

### DETAILED DESCRIPTION OF THE INVENTION

### 1. Configuration

### 1-1. Outline of Notification System

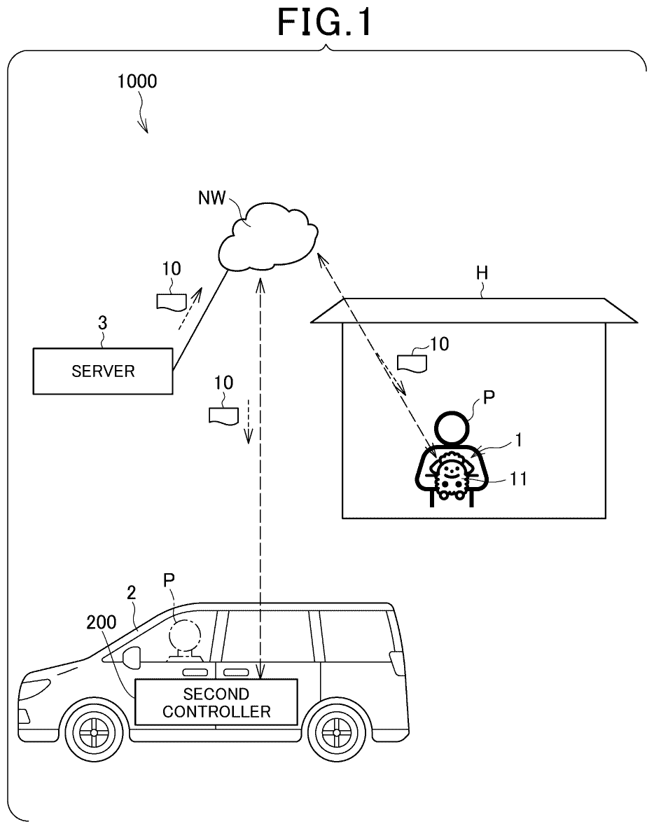

FIG. 1 is a diagram illustrating a configuration of a notification system 1000.

As illustrated in FIG. 1, the notification system 1000 includes a notification device 1, a moving body 2, and a server 3.

The notification system 1000 is a system that gives a notification to a user P. The notification system 1000 gives a warning corresponding to a risk in traffic of the moving body 2 as a notification.

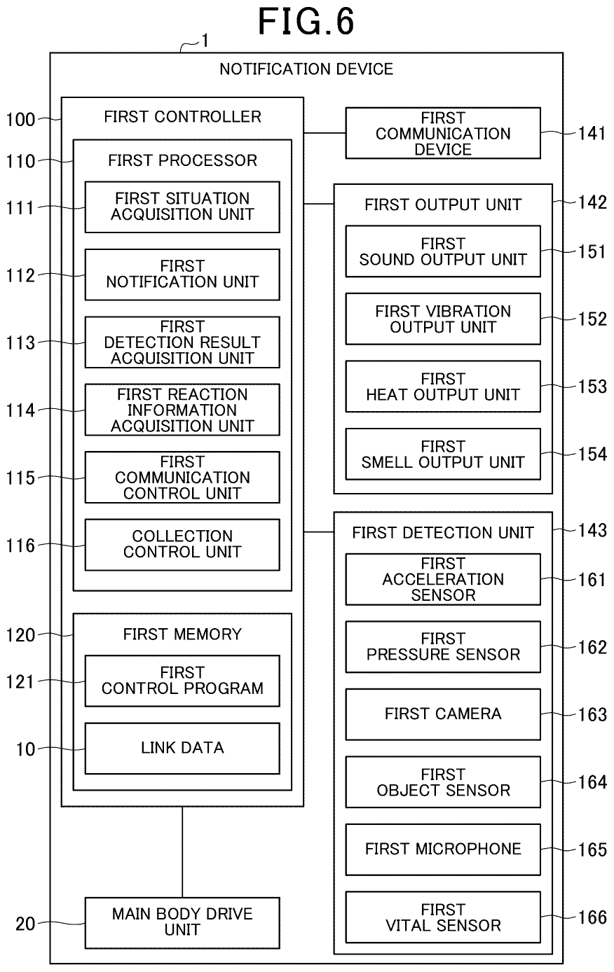

The notification device 1 is a device that the user P uses outside the moving body 2. The notification device 1 is used in a house H such as a home of the user P, for example. The notification device 1 being used indicates that the user P is in contact with the notification device 1. Further, the notification device 1 being used includes a case in which the notification device 1 and the user P are present in a range where the user P can accept a stimulus output by a first output unit 142 (see FIG. 6) provided in the notification device 1, or in a range where a detection result regarding the user P can be obtained by a first detection unit 143 (see FIG. 6).

The notification device 1 is a robot. More precisely, the notification device 1 is a pet robot or a doll robot used by the user P as a toy. Note that the notification device 1 is not limited to a pet robot or a doll robot. It is sufficient that the notification device 1 is a device that the user P can use outside the moving body 2. For example, the notification device 1 may be a so-called wearable device. Examples of the wearable device include devices of a portable terminal, a watch type, a wristband type, a glass type, a ring type, an earphone type, or the like.

The notification device 1 includes a notification device main body 11. The notification device main body 11 includes, for example, a neck part, a body part, a leg part, and the like that can be independently operated.

The notification device 1 is connected to a network NW, and communicates with the moving body 2 or the server 3. Note that the network NW is a communication network formed of a public network, an exclusive line, and other communication circuits or the like.

The moving body 2 is a vehicle. FIG. 1 illustrates a four-wheel vehicle as the moving body 2, however, without being limited thereto, the moving body 2 may be a vehicle with any number of wheels in addition to four wheels, and may be a vehicle other than a car, such as an airplane or a ship. Further, the moving body 2 may be a wearable device such as a portable terminal carried by a pedestrian or an occupant of a vehicle.

The server 3 is a server device that manages the notification device 1 and the moving body 2.

The notification system 1000 primes the user P with a warning of a risk in the traffic of the moving body 2 by giving a notification in advance by the notification device 1. Priming means to make the user P prepare for, before receiving a specific notification or warning, understanding or reaction to the content and importance.

In addition, the notification system 1000 collects reaction information indicating the reaction of the user P to the warnings given in advance by the notification device 1, and determines a mode of a warning appropriate for the user P based on the reaction information. Thus, the notification system 1000 can appropriately give a warning corresponding to the traffic risk in the moving body 2 from viewpoints of a reaction speed, understanding, and acceptability of the user P to the warning.

Hereinafter, a detailed configuration of the notification system 1000 will be described.

### 1-2. Moving Body

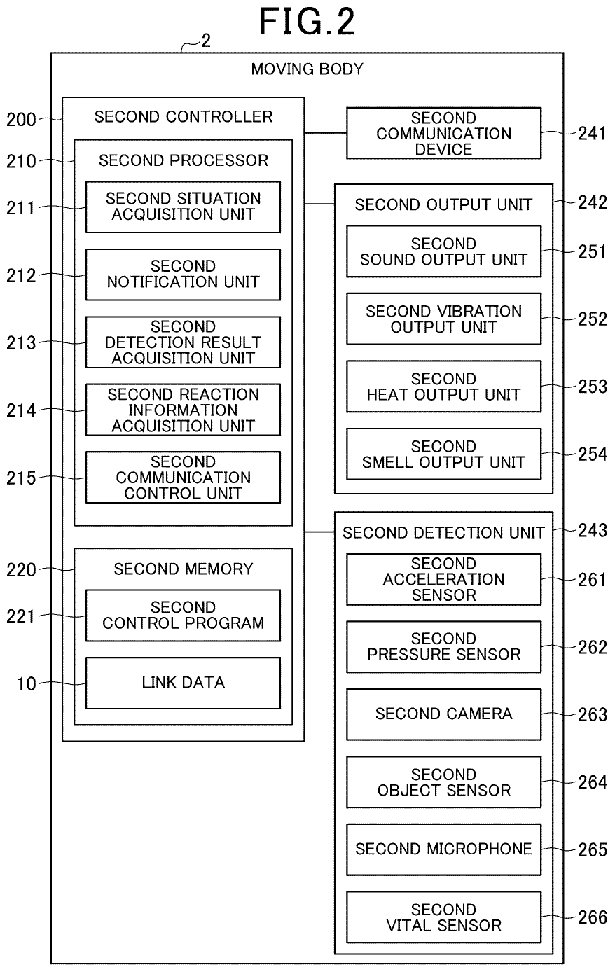

Next, a configuration of the moving body 2 will be described with reference to FIG. 2.

FIG. 2 is a diagram illustrating a configuration of a control system of a second controller 200 of the moving body 2.

The second controller 200 is provided in the moving body 2. The second controller 200 is an example of a “controller”.

The moving body 2 includes a second communication device 241, a second output unit 242, and a second detection unit 243 that are connected to the second controller 200.

Note that devices connected to the second controller 200 are not limited to these devices and devices of other kinds may be also connected.

The second communication device 241 is a communication device that has a transmitter and a receiver, and performs wireless communication based on a communication standard of the notification system 1000. The second communication device 241 is, for example, a TCU (telematics control unit).

The second output unit 242 may be also called a stimulus output means that outputs a stimulus to be given to the user P.

Each unit included in the second output unit 242 outputs or generates a sound, a vibration, heat, and a smell that can be the stimulus. The sound, the vibration, the heat, and the smell are examples of a modality. The modality corresponds to the stimulus that the user P receives through a sensory organ. In addition, the modality may include a visual stimulus such as movement of an image, a change in color, or a sign.

The second output unit 242 includes a second sound output unit 251, a second vibration output unit 252, a second heat output unit 253, and a second smell output unit 254.

The second sound output unit 251 outputs the sound according to control by the second controller 200. The second sound output unit 251 is, for example, a speaker.

The second vibration output unit 252 outputs the vibration according to the control by the second controller 200. The second vibration output unit 252 is, for example, a vibrator. The second vibration output unit 252 is installed, for example, in a seat or a steering wheel of the moving body 2.

The second heat output unit 253 outputs the heat according to the control by the second controller 200. The second heat output unit 253 is, for example, a heater. In addition, the second heat output unit 253 may be formed of a heater and an air blowing device.

The second smell output unit 254 outputs the smell according to the control by the second controller 200. The second smell output unit 254 generates a specific smell by spraying a liquid perfume or vaporizing and blowing a solid or liquid perfume.

The second detection unit 243 includes a second acceleration sensor 261, a second pressure sensor 262, a second camera 263, a second object sensor 264, a second microphone 265, and a second vital sensor 266.

The second acceleration sensor 261 detects accelerations of the moving body 2. The second acceleration sensor 261 includes a gyro sensor or an acceleration sensor. The accelerations detected by the second acceleration sensor 261 include a yaw rate. The number of kinds of the accelerations detected by the second acceleration sensor 261 is larger than the number of kinds of the accelerations detected by a first acceleration sensor 161 of the notification device to be described later. The second acceleration sensor 261 detects two linear accelerations corresponding to directions of two axes different from each other, and the yaw rate, as examples of the accelerations.

The second pressure sensor 262 detects a pressure applied by the user P. The second pressure sensor 262 is, for example, a pressure sensor provided in the steering wheel, and detects force with which the user P grips the steering wheel as a pressure value.

The second camera 263 images at least either inside or outside of the moving body 2. The second camera 263 is, for example, a vehicle interior camera or a vehicle exterior camera.

The second object sensor 264 detects an object around the moving body 2. The second object sensor 264 includes, for example, a human sensor and a distance sensor. In addition, the second object sensor 264 includes, for example, a radar device, a LIDAR (light detection and ranging) sensor, and other various proximity sensors.

The second microphone 265 collects the sound at least either inside or outside the moving body 2.

The second vital sensor 266 detects a vital sign of the user P riding in the moving body 2. The second vital sensor 266 is, for example, a sensor attached to the steering wheel, and detects a heart rate, a breathing pattern, or a body temperature or the like of the user P. In addition, the second vital sensor 266 is, for example, a vital sensor built in a seat, and detects a body weight distribution, a movement, a heart rate, and a breathing rate or the like of the user P.

The second controller 200 includes a second processor 210 such as a CPU (central processing unit) or an MPU (micro processor unit), a second memory 220, and an interface circuit for connecting other devices and sensors.

The second memory 220 is a storage device that stores a program and data. The second memory 220 stores a second control program 221, link data 10, and data processed by the second processor 210. The second memory 220 has a nonvolatile storage area. In addition, the second memory 220 may be provided with a volatile storage area and form a work area of the second processor 210. The second memory 220 is formed of, for example, a ROM (read only memory) or a RAM (random access memory).

The link data 10 is the data indicating link information in which a first notification mode, a first notification condition, a second notification condition, and a second notification mode are linked.

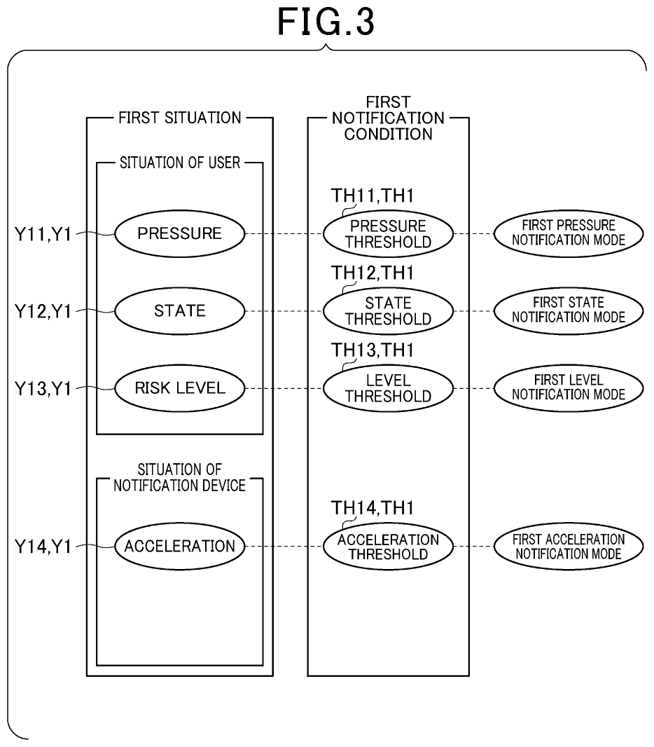

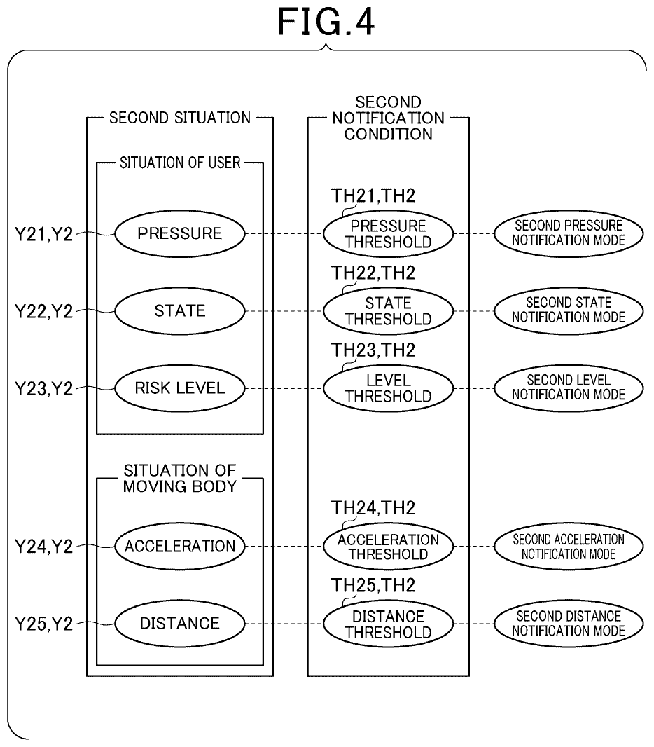

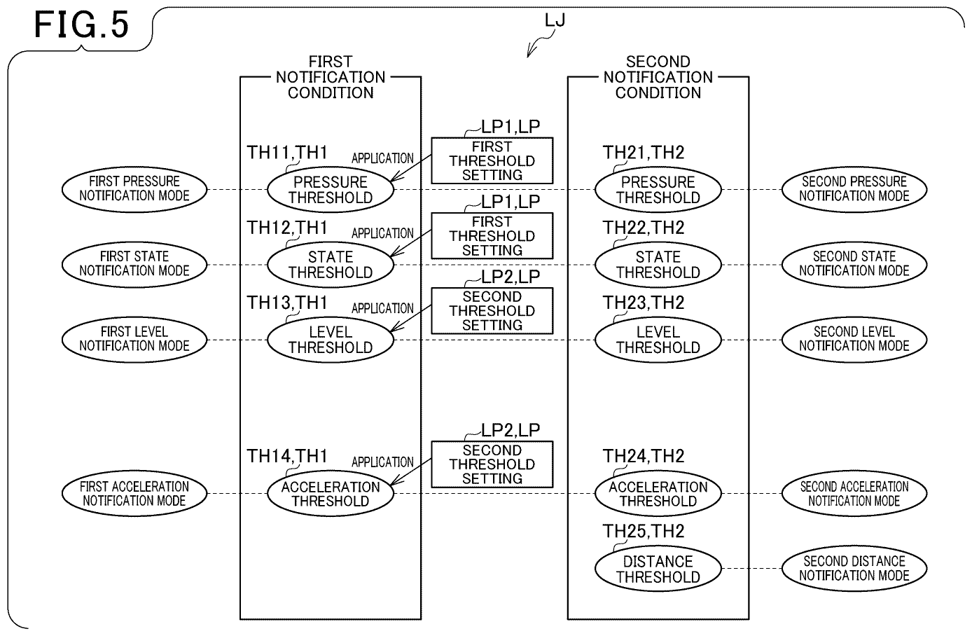

Here, the first notification mode, the first notification condition, the second notification condition, the second notification mode, and the link information will be described with reference to FIG. 3, FIG. 4, and FIG. 5.

First, the first notification condition and the first notification mode will be described with reference to FIG. 3.

FIG. 3 is a diagram for describing the first notification condition and the first notification mode.

First, prior to description of the first notification condition and the first notification mode, a first situation will be described.

As illustrated in FIG. 3, the first situation includes a situation of the user P using the notification device 1, and a situation of the notification device main body 11.

The situation of the user P using the notification device 1 is represented by a plurality of elements Y1. In the present embodiment, the situation of the user P using the notification device 1 includes, as the elements Y1, a first element Y11 indicating a pressure that the user P imparts to the notification device main body 11, a second element Y12 indicating a state of the user P using the notification device 1, and a third element Y13 indicating a level (referred to as a “first risk level”, hereinafter) of the risk of the user P using the notification device 1.

The situation of the notification device main body 11 is represented by the plurality of elements Y1. In the present embodiment, the situation of the notification device main body 11 includes a fourth element Y14 which is the acceleration of the notification device main body 11, as the element Y1.

The first notification condition is a condition provided for the first situation. More precisely, the first notification condition includes a threshold TH1 for each element Y1 included in the first situation.

As illustrated in FIG. 3, the first notification condition has a pressure threshold TH11 for the first element Y11. The pressure threshold TH11 is the threshold TH1 to be compared with the pressure.

In addition, the first notification condition has a state threshold TH12 for the second element Y12. The state threshold TH12 is the threshold TH1 to be compared with a probability that the user P is sleepy.

In addition, the first notification condition has a level threshold TH13 for the third element Y13. The level threshold TH13 is the threshold TH1 to be compared with the first risk level.

Further, the first notification condition has an acceleration threshold TH14 for the fourth element Y14. The acceleration threshold TH14 is the threshold TH1 to be compared with the acceleration.

The first notification mode is a mode of a notification given by the notification device 1. The first notification mode corresponds to each threshold TH1 included in the first notification condition.

To the pressure threshold TH11, a first pressure notification mode which is the first notification mode when the first element Y11 is the pressure threshold TH11 or more corresponds.

To the state threshold TH12, a first state notification mode which is the first notification mode when the second element Y12 is the state threshold TH12 or more corresponds.

To the level threshold TH13, a first level notification mode which is the first notification mode when the third element Y13 is the level threshold TH13 or more corresponds.

To the acceleration threshold TH14, a first acceleration notification mode which is the first notification mode when the fourth element Y14 is the acceleration threshold TH14 or more corresponds.

As illustrated in FIG. 4, a second situation includes a situation of the user P using the moving body 2, and the situation of the moving body 2.

The situation of the user P using the moving body 2 is represented by a plurality of elements Y2. In the present embodiment, the situation of the user P using the moving body 2 includes a first element Y21 which is a pressure that the user P imparts to the moving body 2, a second element Y22 which is a state of the user P using the moving body 2, and a third element Y23 which is a level (referred to as a “second risk level”, hereinafter) of the risk of the user P regarding the traffic.

The situation of the moving body 2 is represented by the plurality of elements Y2. In the present embodiment, the situation of the moving body 2 includes, as elements, a fourth element Y24 which is the acceleration of the moving body 2, and a fifth element Y25 which is a distance between the moving body 2 and the object around the moving body 2.

The second notification condition is the condition provided for the second situation. More precisely, the second notification condition includes a threshold TH2 for each element Y2 included in the second situation.

As illustrated in FIG. 4, the second notification condition has a pressure threshold TH21 for the first element Y21. The pressure threshold TH21 is the threshold TH2 to be compared with the pressure.

In addition, the second notification condition has a state threshold TH22 for the second element Y22. The state threshold TH22 is the threshold TH2 to be compared with the probability that the user P is sleepy.

Further, the second notification condition has a level threshold TH23 for the third element Y23. The level threshold TH23 is the threshold TH2 to be compared with the second risk level.

In addition, the second notification condition has an acceleration threshold TH24 for the fourth element Y24. The acceleration threshold TH24 is the threshold TH2 to be compared with the acceleration.

Further, the second notification condition has a distance threshold TH25 for the fifth element Y25. The distance threshold TH25 is the threshold TH2 to be compared with the distance between the moving body 2 and the object around the moving body 2.

The second notification mode is a mode of a notification given by the moving body 2. The second notification mode corresponds to each threshold TH2 included in the second notification condition.

To the pressure threshold TH21, a second pressure notification mode which is the second notification mode when the first element Y21 is the pressure threshold TH21 or more corresponds.

To the state threshold TH22, a second state notification mode which is the second notification mode when the second element Y22 is the state threshold TH22 or more corresponds.

To the level threshold TH23, a second level notification mode which is the second notification mode when the third element Y23 is the level threshold TH23 or more corresponds.

To the acceleration threshold TH24, a second acceleration notification mode which is the second notification mode when the fourth element Y24 is the acceleration threshold TH24 or more corresponds.

To the distance threshold TH25, a second distance notification mode which is the second notification mode when the fifth element Y25 is the distance threshold TH25 or more corresponds.

FIG. 5 is a diagram for describing link information LJ indicated by the link data 10.

As illustrated in FIG. 5, in the link information LJ, the first notification condition and the first notification mode are linked. More precisely, in the link information LJ, the corresponding first notification mode is linked with each threshold TH1 included in the first notification condition.

In addition, as illustrated in FIG. 5, in the link information LJ, the second notification condition and the second notification mode are linked. More precisely, in the link information LJ, the corresponding second notification mode is linked with each threshold TH2 included in the second notification condition.

As illustrated in FIG. 5, in the link information LJ, the first notification condition to which threshold setting LP is applied and the second notification condition are linked.

The threshold setting LP indicates setting of the threshold TH1 when performing linking. In the present embodiment, for the threshold setting LP, there are first threshold setting LP1 and second threshold setting LP2.

The first threshold setting LP1 is the setting to match with the threshold TH2.

The second threshold setting LP2 is the setting to be smaller than the threshold TH2.

As illustrated in FIG. 5, the first threshold setting LP1 is applied to the pressure threshold TH11, and in the link information LJ, the pressure threshold TH11 to which the first threshold setting LP1 is applied and the pressure threshold TH21 of the second notification condition are linked.

As illustrated in FIG. 5, the first threshold setting LP1 is applied to the state threshold TH12, and in the link information LJ, the state threshold TH12 to which the first threshold setting LP1 is applied and the state threshold TH22 of the second notification condition are linked.

As illustrated in FIG. 5, the second threshold setting LP2 is applied to the level threshold TH13, and in the link information LJ, the level threshold TH13 to which the second threshold setting LP2 is applied and the level threshold TH23 of the second notification condition are linked. When the first risk level and the second risk level are compared, it is assumed that the risk when the moving body 2 is used is larger than the risk when the notification device 1 is used from the viewpoint of the risk to the user P. Therefore, the second threshold setting LP2 is applied to the level threshold TH13. Thus, in the link information LJ, the level threshold TH13 is a changed value changed to be smaller than the level threshold TH23.

As illustrated in FIG. 5, the second threshold setting LP2 is applied to the acceleration threshold TH14, and in the link information LJ, the acceleration threshold TH14 to which the second threshold setting LP2 is applied and the acceleration threshold TH24 of the second notification condition are linked. Between the magnitude of the acceleration generated in the moving body 2 and the magnitude of the acceleration generated in the notification device 1, the acceleration of the notification device 1 is often smaller. This is because the acceleration generated when the moving body 2 travels is greater than the acceleration generated when the notification device 1 is held by the user P and moved. From such a background, the second threshold setting LP2 is applied to the acceleration threshold TH14. Thus, in the link information LJ, the acceleration threshold TH14 is a changed value changed to be smaller than the acceleration threshold TH24.

As illustrated in FIG. 5, no threshold TH1 is linked with the distance threshold TH25. This is because the first notification condition does not include the threshold TH1 corresponding to the distance threshold TH25.

Returning to the description of FIG. 2, the second control program 221 is a program that causes the second processor 210 to function as a functional unit. By reading and executing the second control program 221 stored in the second memory 220, the second processor 210 functions as a second situation acquisition unit 211, a second notification unit 212, a second detection result acquisition unit 213, a second reaction information acquisition unit 214, and a second communication control unit 215.

### 1-2-1. Second Situation Acquisition Unit

The second situation acquisition unit 211 acquires the second situation based on a detection result of the second detection unit 243.

The second situation acquisition unit 211 acquires the pressure value included in the detection result of the second pressure sensor 262 as the first element Y21. For example, the case where the pressure value is larger than a predetermined threshold corresponds to the case where the user P is strongly gripping the steering wheel.

The second situation acquisition unit 211 acquires each acceleration included in the detection result of the second acceleration sensor 261 as the fourth element Y24.

The second situation acquisition unit 211 acquires the distance between the moving body 2 and the object around the moving body 2 included in the detection result of the second object sensor 264 as the fifth element Y25. Examples of the object include a passenger, a building, another moving body, ruggedness on a road surface, an object fallen on a road surface, a structure on a road surface, a sign, and a fence.

Further, the second situation acquisition unit 211 calculates the second risk level based on the detection result of the second object sensor 264, and acquires it as the third element Y23.

The second situation acquisition unit 211 estimates a kind of the object around the moving body 2 according to well-known art, based on the detection result of the second object sensor 264. For example, when the kind of the object that has approached the moving body 2 is a branch of a street tree, the second risk level is low even if it touches the moving body 2, however, when the kind of the object that has approached the moving body 2 is VRU (vulnerable road users), the second risk level is high.

In this way, the second risk level is a standard regarding importance of the risk in the traffic of the moving body 2. The second risk level is a level to be set higher when the importance of the risk regarding the traffic is greater.

The second situation acquisition unit 211 estimates and thus acquires the state of the user P as the second element Y22 according to a conventional technology, based on the detection result of the second vital sensor 266. Examples of the state of the user P include a sleepy state, a nervous state, and a state with low attention. Note that the second situation acquisition unit 211 may use the detection result of the second microphone 265 or the second pressure sensor 262 further to estimate the state of the user P.

The state of the user P is indicated by a probability of being in each state, for example. For example, as the state of the user P, it is indicated that the probability of being in the sleepy state is 90%.

### 1-2-2. Second Notification Unit

The second notification unit 212 gives a notification by the second notification mode when the second situation satisfies the second notification condition. Note that the second situation satisfying the second notification condition means the case where one of the elements Y2 forming the second situation is the corresponding threshold TH2 or more.

The second notification unit 212 gives a notification by the second pressure notification mode when the first element Y21 is the pressure threshold TH21 or more.

The second notification unit 212 gives a notification by the second state notification mode when the second element Y22 is the state threshold TH22 or more.

The second notification unit 212 gives a notification by the second level notification mode when the third element Y23 is the level threshold TH23 or more.

The second notification unit 212 gives a notification by the second acceleration notification mode when the fourth element Y24 is the acceleration threshold TH24 or more.

The second notification unit 212 gives a notification by the second distance notification mode when the fifth element Y25 is the distance threshold TH25 or more.

The second notification unit 212 gives a notification by the second notification mode to the user P riding in the moving body 2 via the second output unit 242. The notification mode includes at least one of the notification mode by the sound, the notification mode by the vibration, the notification mode by the temperature, and the notification mode by the smell.

The notification mode by the sound includes a tone and a pattern of the sound, a character string of a read voice, an intonation of the read voice, a kind of a speaker of the read voice, or the like.

The notification mode by the vibration includes the magnitude of the vibration or a pattern of the vibration or the like.

The notification mode by the temperature includes a height of the temperature or a speed until the temperature changes or the like.

The notification mode by the smell includes a combination of the smell or the like.

In this way, the notification mode is defined by the combination of the modalities themselves and the combination of the patterns of each modality.

### 1-2-3. Second Detection Result Acquisition Unit

The second detection result acquisition unit 213 acquires the detection result regarding the reaction of the user P to the notification by the second notification mode given by the second notification unit 212.

The detection result regarding the reaction of the user P includes the detection result regarding the second notification condition, corresponding to the notification by the second notification mode, the notification being given by the second notification unit 212.

More precisely, when the notification by the second pressure notification mode is given by the second notification unit 212, the detection result of the second detection result acquisition unit 213 includes a temporal change of the pressure value in a predetermined period after the notification.

In addition, when the notification by the second acceleration notification mode is given by the second notification unit 212, the detection result of the second detection result acquisition unit 213 includes a temporal change of the acceleration in the predetermined period after the notification.

Further, when the notification by the second distance notification mode is given by the second notification unit 212, the detection result of the second detection result acquisition unit 213 includes a temporal change of the distance between the moving body 2 and the object around the moving body 2 in the predetermined period after the notification.

In addition, when the notification by the second state notification mode is given by the second notification unit 212, the detection result of the second detection result acquisition unit 213 includes the probability of each state of the user P in the predetermined period after the notification.

Further, the detection result regarding the reaction of the user P includes the detection result of the second microphone 265 in the predetermined period and the detection result of the second camera 263 in the predetermined period after the notification in the second notification mode by the second notification unit 212. The detection result of the second microphone 265 includes a speech of the user P after the notification. The detection result of the second camera 263 includes a photographed image of an expression of the user P after the notification.

### 1-2-4. Second Reaction Information Acquisition Unit

The second reaction information acquisition unit 214 estimates and thus acquires second reaction information, based on the detection result acquired by the second detection result acquisition unit 213.

The second reaction information is the information regarding a degree of the reaction of the user P to the notification by a certain notification mode. The degree of the reaction of the user P includes accuracy of intention understanding for the notification by the user P and the degree of a load of recognition for the notification by the user P.

The degree of the reaction of the user P includes a reaction speed for the notification by a certain notification mode, the understanding for the notification by a certain notification mode, and the acceptability for the notification by a certain notification mode.

The reaction speed corresponds to time from a situation in which the second situation satisfies the second notification condition to a situation in which the second situation does not satisfy the second notification condition.

More specifically, the reaction speed corresponds to the time until the pressure value becomes lower than the pressure threshold TH21. In addition, more specifically, the reaction speed corresponds to the time until the acceleration of the moving body 2 becomes lower than the acceleration threshold TH24. Further, more specifically, the reaction speed corresponds to the time until the distance between the moving body 2 and the object around the moving body 2 becomes lower than the distance threshold TH25. In addition, more specifically, the reaction speed corresponds to the time until the probability that the user P is in the sleepy state becomes lower than the predetermined state threshold TH22.

The understanding corresponds to the understanding of an intention of the user P in the content of the notification of a certain mode.

The second reaction information acquisition unit 214 estimates the understanding by using an estimation model that estimates the understanding based on the detection result acquired by the second detection result acquisition unit 213.

In particular, the understanding and the speech and the expression of the user P after the notification are correlated.

For example, when wording of the speech of the user P after the notification is the content presenting a question, it is estimated that the understanding is low. In addition, when the voice of the speech indicates a feeling presenting a question, it is estimated that the understanding is low. Further, when the expression of the user P indicates the feeling presenting a question, it is estimated that the understanding is low.

The acceptability corresponds to the degree of how much the notification of a certain mode is accepted by the user P. The higher the acceptability, the less the user P feels troublesome for the notification, and continuous use of the system can be expected.

The second reaction information acquisition unit 214 estimates the acceptability by using the estimation model that estimates the acceptability based on the detection result acquired by the second detection result acquisition unit 213.

In particular, the acceptability and the speech and the expression of the user P after the notification are correlated.

For example, when the wording of the speech of the user P after the notification is the content presenting troublesomeness or disgust for the notification, it is estimated that the acceptability is low. In addition, when the voice of the speech indicates a feeling presenting the troublesomeness or the disgust, it is estimated that the acceptability is low. Further, when the expression of the user P indicates the feeling presenting the troublesomeness or the disgust, it is estimated that the acceptability is low. Further, when the reaction of the user P indicates that the user intentionally ignores the notification, it is estimated that the acceptability is low.

The estimation model is a model which has machine-learned a relation between the voice of the speech of the user P and the expression of the user P, and the reaction speed, the understanding, and the acceptability, for example. For machine learning, for example, a method of deep learning or the like is used.

The second reaction information acquisition unit 214 estimates and acquires the degree of the reaction of the user P based on the reaction speed, the understanding, and the acceptability. A relation between the reaction speed, the understanding, and the acceptability, and the degree of the reaction is predetermined, and the second reaction information acquisition unit 214 estimates the degree of the reaction of the user P by a rule-based method for example. The degree of the reaction of the user may be represented by discrete ranking, represented by a specific numerical value, or represented by scoring. Further, instead of the rule-based method, the model which has machine-learned the relation between the reaction speed, the understanding, and the acceptability of the user P and the degree of the reaction of the user P may be used.

Note that the reaction speed, the understanding, and the acceptability are exemplified as the viewpoint of the degree of the reaction of the user P, however, it is not limited thereto. As the viewpoint of the degree of the reaction of the user P, the viewpoint of the load of the recognition including a burden on the user P to understand and arrange the content of the notification or the like may be included. In this case, for example, when the notification mode is the mode using words, the user P needs to understand the meaning of the words so that the load of the recognition may be relatively large, and on the other hand, when the notification mode is the mode using the sound or light, the load of the recognition may be relatively small.

### 1-2-5. Second Communication Control Unit

The second communication control unit 215 communicates with the notification device 1 or the server 3 via the second communication device 241.

The second communication control unit 215 receives the link data 10 transmitted from the server 3.

### 1-3. Notification Device

Next, a configuration of the notification device 1 will be described with reference to FIG. 6.

FIG. 6 is a diagram illustrating a configuration of a control system of a first controller 100 of the notification device 1.

The first controller 100 is provided in the notification device 1.

The notification device 1 includes a first communication device 141, the first output unit 142, the first detection unit 143, and a main body drive unit 20 connected to the first controller 100.

Note that devices connected to the first controller 100 are not limited to these devices and devices of other kinds may be also connected.

The first communication device 141 is a communication device that has a transmitter and a receiver, and performs wireless communication based on the communication standard of the notification system 1000.

The first output unit 142 may be also called a stimulus output means that outputs a stimulus to be given to the user P, similarly to the second output unit 242.

Each unit included in the first output unit 142 outputs or generates a sound, a vibration, heat, and a smell that can be the stimulus, similarly to the second output unit 242.

The first output unit 142 includes a first sound output unit 151, a first vibration output unit 152, a first heat output unit 153, and a first smell output unit 154.

The first sound output unit 151 outputs the sound according to control by the first controller 100. The first sound output unit 151 is, for example, a speaker.

The first vibration output unit 152 outputs the vibration according to the control by the first controller 100. The first vibration output unit 152 is, for example, a vibrator.

The first heat output unit 153 outputs the heat according to the control by the first controller 100. The first heat output unit 153 is, for example, a heater. In addition, the first heat output unit 153 may be formed of a heater and an air blowing device.

The first smell output unit 154 outputs the smell according to the control by the first controller 100. The first smell output unit 154 generates a specific smell by spraying a liquid perfume or vaporizing and blowing a solid or liquid perfume.

The first detection unit 143 includes the first acceleration sensor 161, a first pressure sensor 162, a first camera 163, a first object sensor 164, a first microphone 165, and a first vital sensor 166.

The first acceleration sensor 161 detects accelerations of the notification device 1. The first acceleration sensor 161 detects the smaller number of the accelerations than the number of the kinds of the accelerations detected by the second acceleration sensor 261 of the moving body 2. For example, the first acceleration sensor 161 does not detect a yaw rate. The first acceleration sensor 161 detects a linear acceleration corresponding to a certain axis as the acceleration.

The first pressure sensor 162 detects a pressure applied by the user P. The first pressure sensor 162 is, for example, a pressure sensor provided in the notification device main body 11, and detects force with which the user P holds the notification device main body 11 as a pressure value.

The first camera 163 images a periphery of the notification device 1.

The first object sensor 164 detects an object around the notification device 1. The first object sensor 164 includes, for example, a human sensor and a distance sensor. In addition, the first object sensor 164 includes, for example, a radar device, a LIDAR (light detection and ranging) sensor, and other various proximity sensors.

The first microphone 165 collects the sound around the notification device 1.

The first vital sensor 166 detects a vital sign of the user P using the notification device 1. The first vital sensor 166 detects a heart rate, a breathing pattern, or a body temperature or the like of the user P.

The main body drive unit 20 is a drive unit that drives each part of the notification device main body 11.

The first controller 100 includes a first processor 110 such as a CPU (central processing unit) or an MPU (micro processor unit), a first memory 120, and an interface circuit for connecting other devices and sensors.

The first memory 120 is a storage device that stores a program and data. The first memory 120 stores a first control program 121, the link data 10, and data processed by the first processor 110. The first memory 120 has a nonvolatile storage area. In addition, the first memory 120 may be provided with a volatile storage area and form a work area of the first processor 110. The first memory 120 is formed of, for example, a ROM (read only memory) or a RAM (random access memory).

The first control program 121 is an example of a “program”.

The first control program 121 is a program that causes the first processor 110 to function as a functional unit. By reading and executing the first control program 121 stored in the first memory 120, the first processor 110 functions as a first situation acquisition unit 111, a first notification unit 112, a first detection result acquisition unit 113, a first reaction information acquisition unit 114, and a first communication control unit 115.

### 1-3-1. First Situation Acquisition Unit

The first situation acquisition unit 111 acquires the first situation based on the detection result of the first detection unit 143.

The first situation acquisition unit 111 acquires the pressure value included in the detection result of the first pressure sensor 162 as the first element Y11. For example, the case where the pressure value is larger than the predetermined threshold corresponds to the case where the user P is strongly gripping or strongly holding the notification device main body 11.

The first situation acquisition unit 111 acquires the acceleration included in the detection result of the first acceleration sensor 161 as the fourth element Y14.

Further, the first situation acquisition unit 111 calculates the first risk level based on the detection result of the first object sensor 164, and acquires it as the third element Y13. The first situation acquisition unit 111 estimates the kind of the object around the notification device 1 according to the well-known art, based on the detection result of the first object sensor 164.

For example, it is assumed that the notification device 1 held by the user P suddenly approaches and is about to touch another person in the house H. The first situation acquisition unit 111 makes the detection result corresponding to such a case correspond to the case where the kind of the object that has approached the moving body 2 is the VRU, and calculates the first risk level.

The detection result of the first object sensor 164 provided in the notification device 1 is made to correspond to the detection result of the second object sensor 264 provided in the moving body 2 in advance from the viewpoint of the degree of similarity between the risk in the traffic and the situation.

In this way, the first risk level in the notification device 1 is calculated by a standard corresponding to a standard regarding the importance of the risk in the traffic of the moving body 2.

The first situation acquisition unit 111 estimates and thus acquires the state of the user P as the second element Y12 according to the conventional technology, based on the detection result of the first vital sensor 166. Examples of the state of the user P include a sleepy state, a nervous state, and a state with low attention. Note that the first situation acquisition unit 111 may use the detection result of the first microphone 165 or the first pressure sensor 162 further to estimate the state of the user P.

The state of the user P is indicated by the probability of being in each state, for example. For example, as the state of the user P, it is indicated that the probability of being in the sleepy state is 90%.

In this way, the state of the user P is included in the element representing the first situation.

### 1-3-2. First Notification Unit

The first notification unit 112 gives a notification by the first notification mode when the first situation satisfies the first notification condition. Note that the first situation satisfying the first notification condition means the case where one of the elements Y1 forming the first situation is the corresponding threshold TH1 or more.

The first notification unit 112 gives a notification by the first pressure notification mode when the first element Y11 is the pressure threshold TH11 or more.

The first notification unit 112 gives a notification by the first state notification mode when the second element Y12 is the state threshold TH12 or more.

The first notification unit 112 gives a notification by the first level notification mode when the third element Y13 is the level threshold TH13 or more.

The first notification unit 112 gives a notification by the first acceleration notification mode when the fourth element Y14 is the acceleration threshold TH14 or more.

The first notification unit 112 gives a notification by the first notification mode to the user P using the notification device 1 via the first output unit 142.

### 1-3-3. First Detection Result Acquisition Unit

The first detection result acquisition unit 113 acquires the detection result regarding the reaction of the user P to the notification by the first notification mode given by the first notification unit 112.

The detection result regarding the reaction of the user P includes the detection result regarding the first notification condition, corresponding to the notification by the first notification mode, the notification being given by the first notification unit 112.

More precisely, when the notification by the first pressure notification mode is given by the first notification unit 112, the detection result of the first detection result acquisition unit 113 includes the temporal change of the pressure value in the predetermined period after the notification.

In addition, when the notification by the first acceleration notification mode is given by the first notification unit 112, the detection result of the first detection result acquisition unit 113 includes the temporal change of the acceleration in the predetermined period after the notification.

Further, when the notification by the first distance notification mode is given by the first notification unit 112, the detection result of the first detection result acquisition unit 113 includes the temporal change of the distance between the notification device 1 and the object around the notification device 1 in the predetermined period after the notification.

In addition, when the notification by the first state notification mode is given by the first notification unit 112, the detection result of the first detection result acquisition unit 113 includes the probability of each state of the user P in the predetermined period after the notification.

Further, the detection result regarding the reaction of the user P includes the detection result of the first microphone 165 in the predetermined period and the detection result of the first camera 163 in the predetermined period after the notification in the first notification mode by the first notification unit 112. The detection result of the first microphone 165 includes the speech of the user P after the notification. The detection result of the first camera 163 includes the photographed image of the expression of the user P after the notification.

### 1-3-4. First Reaction Information Acquisition Unit

The first reaction information acquisition unit 114 estimates and thus acquires first reaction information, based on the detection result acquired by the first detection result acquisition unit 113.

The description of a method with which the first reaction information acquisition unit 114 acquires the first reaction information is similar to the description of the method with which the second reaction information acquisition unit 214 acquires the second reaction information.

### 1-3-5. First Communication Control Unit

The first communication control unit 115 communicates with the moving body 2 or the server 3 via the first communication device 141.

The first communication control unit 115 receives and thus acquires the link data 10 transmitted from the server 3. The first communication control unit 115 is an example of a “link information acquisition unit”.

### 1-3-6. Collection Control Unit

A collection control unit 116 performs collection control by operating the notification device main body 11 by driving the main body drive unit 20 or outputting the sound by the first sound output unit 151.

The collection control includes controlling the notification device 1 as a so-called pet robot according to the well-known art. Further, the collection control includes control for collecting the first reaction information of the user P.

The collection control unit 116 expresses a predetermined gesture by operating each part (for example, a neck part, a leg part, and a body part or the like) of the notification device main body 11 by the main body drive unit 20. In addition, the collection control unit 116 outputs a cry or a voice by the first sound output unit 151.

The collection control unit 116 outputs the voice of “Hold me” or “I want to go there” or the like, for example, and expresses a gesture of begging the user P by operating each part of the notification device main body 11. In this way, the collection control unit 116 performs the collection control that urges the user P to hold or move the notification device 1.

### 1-4. Server

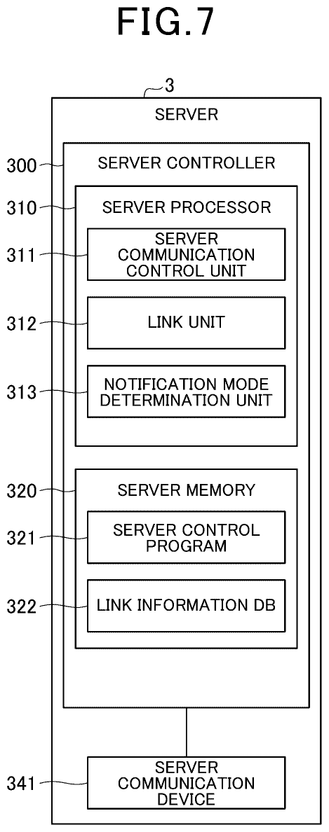

Next, a configuration of the server 3 will be described with reference to FIG. 7.

FIG. 7 is a diagram illustrating a configuration of a control system of a server controller 300 of the server 3.

The server controller 300 is provided in the server 3.

The server 3 includes a server communication device 341 connected to the server controller 300.

The server communication device 341 is a communication device that has a transmitter and a receiver, and performs wireless communication based on the communication standard of the notification system 1000.

The server controller 300 includes a server processor 310 such as a CPU (central processing unit) or an MPU (micro processor unit), a server memory 320, and an interface circuit for connecting other devices and sensors.

The server memory 320 is a storage device that stores a program and data. The server memory 320 stores a server control program 321, a link information DB (database) 322, and data processed by the server processor 310. The server memory 320 has a nonvolatile storage area. In addition, the server memory 320 may be provided with a volatile storage area and form a work area of the server processor 310. The server memory 320 is formed of, for example, a ROM (read only memory) or a RAM (random access memory).

In one record stored by the link information DB 322, identification information that uniquely specifies the notification device 1 and the moving body 2 used by the user P, and the first reaction information, the second reaction information, user information, and the link information LJ, that are associated with the identification information, are stored. The user information is the information indicating personal information of the user P using the notification device 1 and the moving body 2. The user information includes a sex, an age, and the like of the user P. In addition, the user information may be the information related to a life of the user P, the information being collected by the notification device 1, the moving body 2, or the other devices used by the user P.

The server control program 321 is a program that causes the server processor 310 to function as a functional unit. By reading and executing the server control program 321 stored in the server memory 320, the server processor 310 functions as a server communication control unit 311, a link unit 312, and a notification mode determination unit 313.

The link unit 312 is an example of the “link information acquisition unit”.

### 1-4-1. Server Communication Control Unit

The server communication control unit 311 communicates with the notification device 1 or the moving body 2 via the server communication device 341.

The server communication control unit 311 transmits the link data 10 to the notification device 1 or the moving body 2.

The server communication control unit 311 receives and thus acquires the reaction information from the notification device 1 or the moving body 2. Note that the reaction information is a generic name of the first reaction information and the second reaction information without a distinction.

In addition, the server communication control unit 311 manages the link information DB 322.

### 1-4-2. Link Unit

The link unit 312 generates the link information LJ, and also generates the link data 10.

### 1-4-3. Notification Mode Determination Unit

The notification mode determination unit 313 determines the first notification mode associated with the first notification condition and the second notification mode associated with the second notification condition, based on the reaction information acquired from the notification device 1 or the moving body 2. The information regarding the first notification mode and the second notification mode determined by the notification mode determination unit 313 is included in the link information LJ.

The reaction information indicates the degree of the reaction of the user P to a certain notification mode. The notification mode determination unit 313 inputs the reaction information, and estimates and thus determines the notification mode that improves the degree of the reaction of the user P as output, based on the estimation model.

The estimation model used by the notification mode determination unit 313 is the model which has machine-learned the relation between the reaction information and the notification mode, for example. For machine learning, for example, the method of deep learning or the like is used. Note that input of the estimation model may include the user information in addition to the reaction information.

The user information includes the personal information such as the age or the sex of the user P and recording information related to the life of the user P. In this case, the estimation model used by the notification mode determination unit 313 is the model which has machine-learned the relation between the reaction information and the user information, and the notification mode.

When a predetermined instruction trigger is generated, the notification mode determination unit 313 instructs the notification device 1 to collect specific first reaction information. The notification mode determination unit 313 is an example of an “instruction unit”.

An instruction to collect the specific first reaction information includes an instruction for the notification device 1 to perform the collection control so as to easily satisfy a specific first notification condition. For example, when the specific first notification condition corresponding to specific reaction information is represented by the acceleration threshold TH1, begging the user P to move from the notification device 1 so that the acceleration of the notification device 1 easily changes corresponds to collecting the specific reaction information. In this way, the collection control to easily satisfy the notification condition is that the notification device 1 is controlled such that the element of the situation under the certain first notification condition easily fluctuates.

The specific first reaction information is lacking first reaction information. More precisely, the specific first reaction information is the first reaction information which is not obtained at all or is obtained only for the predetermined number or less of pieces. In other words, the specific first reaction information is the first reaction information corresponding to the mode of the notification which has not been given or has been given for the small number of times.

For example, in the notification device 1, if the notification by the combination of the sound and the vibration as the combination of the modalities themselves is not given, it is defined that the first reaction information corresponding to the notification mode is lacking.

In addition, for example, it is assumed that there are a sound pattern A and a sound pattern B for modality patterns in the sound and there are a vibration pattern A and a vibration pattern B for modality patterns in the vibration. In this case, it is assumed that the predetermined number or more of pieces of the first reaction information corresponding to the combination of the sound pattern A and the vibration pattern A, the combination of the sound pattern A and the vibration pattern B, and the combination of the sound pattern B and the vibration pattern A as the notification mode have been obtained. Further, in this case, it is assumed that only the predetermined number or less of pieces of the first reaction information corresponding to the combination of the sound pattern B and the vibration pattern B have been obtained. In this case, in the notification device 1, since the number of times that the notification is given by the combination of the sound pattern B and the vibration pattern B as the combination of the modality patterns is small, it is defined that the first reaction information corresponding to the notification mode is lacking.

The instruction trigger is generated when the notification by the second notification mode is actually given in the moving body 2 and the number of pieces of the first reaction information corresponding to the notification is the predetermined number or less. The predetermined number is determined beforehand corresponding to each first reaction information corresponding to each notification mode.

In addition, the instruction trigger is generated when the notification mode determination unit 313 has changed the second notification mode corresponding to an arbitrary second notification condition, based on the second reaction information corresponding to the notification by the second notification mode in particular. Such a case corresponds to, for example, the case where it is estimated that the second notification mode before the change is not appropriate from the viewpoint of the degree of the reaction of the user P in the moving body 2 by estimation by the notification mode determination unit 313. In other words, it corresponds to the case where the notification mode is not appropriate in the moving body 2.

### 2. Operation

First, operations of the server 3, the notification device 1, and the moving body 2 regarding the link information will be described.

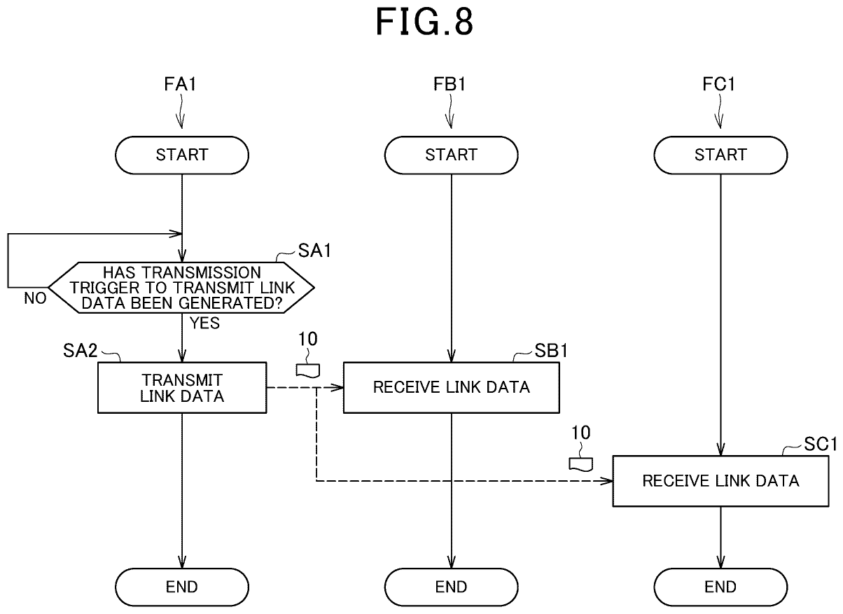

FIG. 8 is a flowchart illustrating the operations of the server 3, the notification device 1, and the moving body 2. In FIG. 8, a flowchart FA1 illustrates the operation of the server 3, a flowchart FB1 illustrates the operation of the notification device 1, and a flowchart FC1 illustrates the operation of the moving body 2.

In the operation of the server 3 illustrated in FIG. 8, it is assumed that the server 3 generates the link information mainly by the operations of the link unit 312 and the notification mode determination unit 313.

As illustrated in the flowchart FA1, the server communication control unit 311 of the server 3 determines whether or not a transmission trigger to transmit the link data 10 indicating the link information has been generated (step SA1).

Examples of the transmission trigger include whether or not the link information has been changed by the link unit 312 or the notification mode determination unit 313, whether or not the predetermined period has elapsed, or whether or not the predetermined time has come.

If the transmission trigger has not been generated (step SA1: NO), the server communication control unit 311 repeats determination in step SA1.

If the transmission trigger has been generated (step SA1: YES), the server communication control unit 311 transmits the link data 10 indicating the link information to the notification device 1 and the moving body 2 (step SA2).

As illustrated in the flowchart FB1, the first communication control unit 115 of the notification device 1 receives and thus acquires the link data 10 from the server 3 (step SB1). Step SB1 is an example of a “link information acquisition step”.

As illustrated in the flowchart FC1, the second communication control unit 215 of the moving body 2 receives and thus acquires the link data 10 from the server 3 (step SC1).

Next, the operation of the notification device 1 will be described.

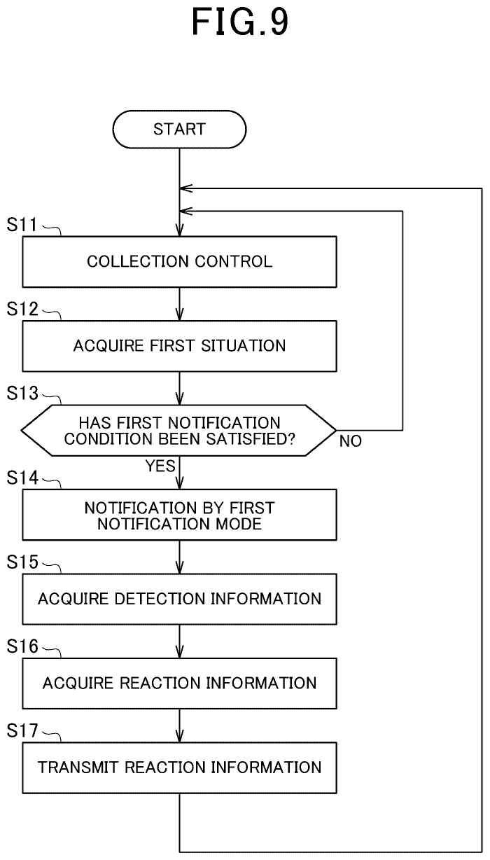

FIG. 9 is a flowchart illustrating the operation of the notification device 1.

The collection control unit 116 performs the collection control (step S11). Then, the first situation acquisition unit 111 acquires the first situation (step S12). Step S12 is an example of a “first situation acquisition step”.

Next, the first notification unit 112 refers to the link data 10 and determines whether or not the first situation has satisfied the first notification condition (step S13).

If the first notification unit 112 determines that the first situation has not satisfied the first notification condition (step S13: NO), processing is returned to step S11, and the collection control by the collection control unit 116 is performed again.

As illustrated from step S11 to step S13, the notification device 1 repeats the collection control by the collection control unit 116, acquisition of the first situation by the first situation acquisition unit 111, and the determination regarding the first notification condition by the first notification unit 112.

If the first situation has satisfied the first notification condition (step S13: YES), the first notification unit 112 refers to the link data 10, specifies the second notification condition linked with the first notification condition, specifies the second notification mode linked with the specified second notification condition, and gives a notification by the first notification mode matched with the specified second notification mode (step S14). In this way, based on the link data 10, in step S14, the notification mode in the notification of the first notification unit 112 is matched with the notification mode of the second notification unit 212.

Step S14 is an example of a “first notification step”.

Next, the first detection result acquisition unit 113 acquires the detection result after the notification by the first notification mode (step S15). Then, the first reaction information acquisition unit 114 acquires the reaction information based on the detection result (step S16).

Next, the first communication control unit 115 transmits first reaction information data including the reaction information to the server 3 (step S17). The server 3 receives the first reaction information data, and stores it in the link information DB 322.

After step S17 ends, the first control program 121 returns the processing to step S11. The notification device 1 repeatedly executes the processing illustrated in FIG. 9 as long as a power source of the notification device 1 is not turned OFF.

Next, the operation of the moving body 2 will be described.

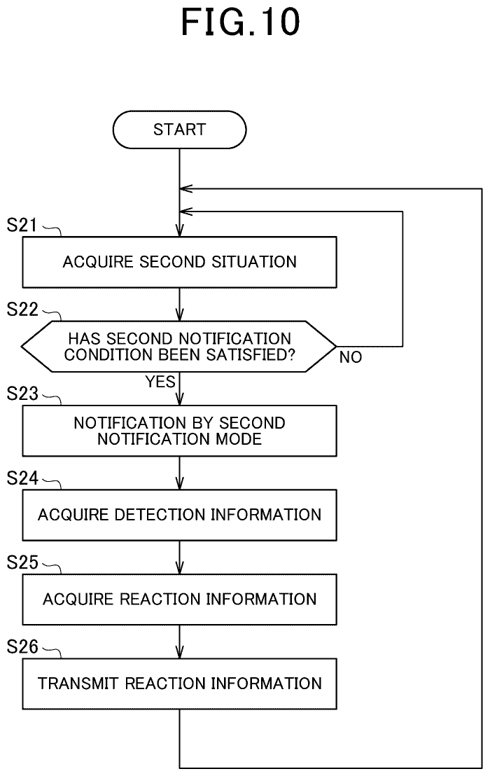

FIG. 10 is a flowchart illustrating the operation of the second controller 200 of the moving body 2.

In the operation of the moving body 2 illustrated in FIG. 10, it is assumed that a power source of the moving body 2 is turned ON and driving of the moving body 2 has been started. The driving of the moving body 2 includes, with the user P riding in the moving body 2, that the moving body 2 is traveling and stopping.

The second situation acquisition unit 211 acquires the second situation (step S21).

Step S21 is an example of a “second situation acquisition step”.

Then, the second notification unit 212 refers to the link data 10 and determines whether or not the second situation has satisfied the second notification condition (step S22).

If the second notification unit 212 determines that the second situation has not satisfied the second notification condition (step S22: NO), processing is returned to step S21.

As illustrated in step S21 and step S22, the moving body 2 repeats the acquisition of the second situation by the second situation acquisition unit 211 and the determination regarding the second notification condition by the second notification unit 212 while the moving body 2 is driven.

If the second situation has satisfied the second notification condition (step S22: YES), the second notification unit 212 refers to the link data 10, and gives a notification by the second notification mode (step S23).

Step S23 is an example of a “second notification step”.

Next, the second detection result acquisition unit 213 acquires the detection result after the notification by the second notification mode (step S24).

Then, the second reaction information acquisition unit 214 acquires the reaction information based on the detection result (step S25).

Next, the second communication control unit 215 transmits second reaction information data including the reaction information to the server 3 (step S26). The server 3 receives the second reaction information data, and stores it in the link information DB 322.

After step S26 ends, the second control program 221 returns the processing to step S21. The moving body 2 repeatedly executes the processing illustrated in FIG. 10 as long as the power source of the moving body 2 is not turned OFF and the driving continues.

Here, a utilization example of the notification system 1000 will be described.

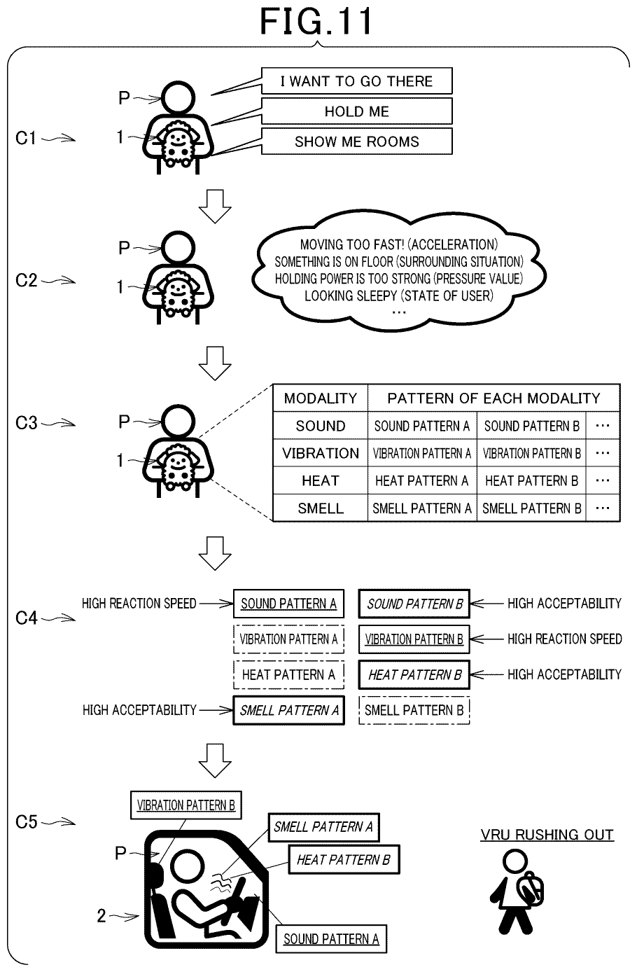

FIG. 11 is a schematic diagram describing the utilization example of the notification system 1000.

FIG. 11 illustrates five situations C1, C2, C3, C4, and C5.

The situation C1 is a cycle corresponding to step S11 described in FIG. 9 in particular. In the situation C1, the notification device 1 is operated in order to perform the priming with the notification and to collect the reaction information of the user P by giving the notification by the first notification mode to the user P.

The notification device 1 urges the user P to move holding the notification device 1 by the voice of “I want to go there” or the like, to hold the notification device 1 by the voice of “Hold me” or the like, or to show the inside of the house H of the user P using the notification device 1 by the voice of “Show me rooms” or the like. Thus, an opportunity to acquire the first situation as illustrated in the situation C2 increases. Consequently, the number of times of the notification of the notification device 1 increases, and an opportunity to obtain the reaction information increases. The situation C2 is a cycle corresponding to step S12 described in FIG. 9 in particular.

The situation C3 illustrates the mode of the notification given by the notification device 1. As described above, the notification device 1 can give the notification for which the modalities themselves or the patterns of each modality are combined. By giving the notification by the notification mode as illustrated in the situation C3, the user P is primed with the notification.

The situation C4 is a cycle corresponding to step S16 described in FIG. 9 in particular. As illustrated in the situation C4, the notification device 1 estimates the reaction speed or the acceptability for each pattern of each modality. The notification device 1 actually gives the notification and collects the reaction information of the user P. Thus, the notification system 1000 can determine the notification mode with the appropriate degree of the reaction of the user P, for the individual user P.

The situation C5 is a cycle corresponding to steps S22 and S23 described in FIG. 10 in particular. The situation C5 exemplifies the case where the VRU rushes out in front of the moving body 2. Further, the situation C5 exemplifies the combination of the sound pattern A, the vibration pattern B, a heat pattern B, and a smell pattern A, as the second notification mode.

In the example illustrated in FIG. 11, the notification by the first notification mode that matches with the second notification mode illustrated in the situation C5 has been already given to the user P in the situation C3. Therefore, the user P in the situation C5 has been primed with the notification by the second notification mode in the case where the VRU rushes out. Thus, the user P easily reacts to the situation of the moving body 2 that the VRU rushes out, and the traffic risk can be reduced.

In particular, it is assumed that the number of times of the notification in the first notification mode in the notification device 1 becomes larger than that of the notification in the second notification mode in the moving body 2 by repetition of the situations C1, C2, and C3. Thus, the reaction information corresponding to a certain notification mode is relatively often obtained from the notification device 1. Therefore, the notification mode determination unit 313 of the server 3 described above often determines the second notification mode based on the reaction information acquired from the notification device 1 in particular.

Next, the operation of the server 3 will be described.

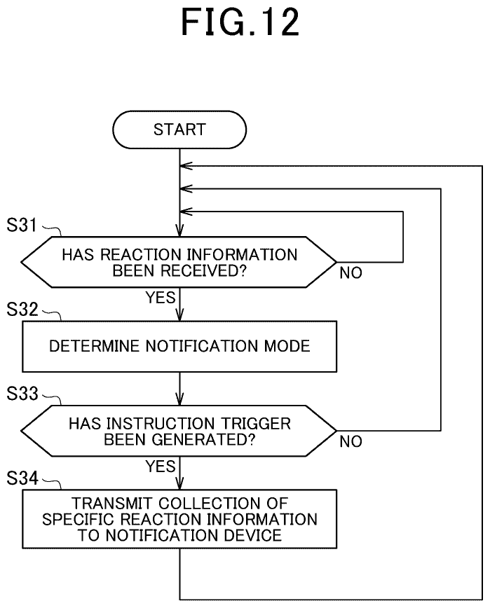

FIG. 12 is a flowchart illustrating the operation of the server 3.

The server communication control unit 311 determines whether or not the reaction information has been received from the notification device 1 or the moving body 2 (step S31). If the reaction information has not been received from the notification device 1 or the moving body 2 (step S31: NO), the server communication control unit 311 repeats the determination.

If the server communication control unit 311 has received the reaction information from the notification device 1 or the moving body 2 (step S31: YES), the notification mode determination unit 313 determines the first notification mode or the second notification mode (step S32).

Next, the notification mode determination unit 313 determines whether or not the instruction trigger has been generated (step S33), and if the instruction trigger has not been generated (step S33: NO), returns the processing to step S31.

If the instruction trigger has been generated (step S33: YES), the notification mode determination unit 313 transmits instruction data including an instruction to collect the specific reaction information to the notification device 1 (step S34). Upon reception of the instruction data, the notification device 1 performs the collection control so as to easily satisfy the specific first notification condition.

In this way, the notification mode determination unit 313 determines the second notification mode of the second notification unit 212 based on the second reaction information, and when the second notification mode is changed by the notification mode determination unit 313, instructs the first notification unit 112 to give a notification by the second notification mode. More precisely, by changing the second notification mode, the first notification mode corresponding to the second notification mode is also changed in the link information LJ. By the instruction, the notification device 1 performs the collection control so as to easily satisfy the specific first notification condition linked with the second notification mode. Thus, by the instruction in step S34, the first notification unit 112 gives a notification by the changed second notification mode.

After step S34 ends, the server control program 321 returns the processing to step S31. The server 3 repeatedly executes the processing illustrated in FIG. 12 as long as a power source of the server 3 is not turned OFF.

### 3. Other Embodiments

The embodiment described above merely illustrates one aspect, and arbitrary modifications and applications are possible.

In the embodiment described above, the server 3 is configured to determine the notification mode. In another embodiment, the second controller 200 of the moving body 2 may be configured to determine the notification mode. In the case of this configuration, the moving body 2 acquires the reaction information of the notification by the first notification mode from the notification device 1.

In this case, the second processor 210 provided in the second controller 200 of the moving body 2 is an example of an “acquisition unit” of a “controller”. Then, in the case of this configuration, the second processor 210 functions as the link unit 312 as an example of the link information acquisition unit and the notification mode determination unit 313 further, determines the notification mode based on the reaction information in the notification device 1 and the moving body 2, and generates the link data 10.

In the embodiment described above, the acceleration, the pressure value, the distance from the object around the notification device main body 11 or the moving body 2, and the probability that the user P is in a certain state are exemplified as the elements, however, they are not limited thereto. In another embodiment, the acceleration as the element may be defined separately as the acceleration in a vertical direction, a perpendicular direction, or a rotating direction. In addition, as the element, a parameter that can be defined in common to the situation of the notification device main body 11 or the situation of the moving body 2 may be appropriately defined.

Further, the element to which the threshold setting LP that links the first notification condition and the second notification condition is applied may be appropriately changed.

In the embodiment described above, the configuration is exemplified in which the second situation is represented by the plurality of elements Y2, the second notification condition is represented including the pressure threshold TH21, the state threshold TH22, the level threshold TH23, the acceleration threshold TH24, and the distance threshold TH25 as thresholds of the first element Y21, the second element Y22, the third element Y23, the fourth element Y24, and the fifth element Y25, and the first notification condition includes the pressure threshold TH11, the state threshold TH12, the level threshold TH13, and the acceleration threshold TH14 that are some of the plurality of thresholds in the link information LJ, however, it is not limited thereto. For example, the second notification condition may be represented including thresholds of the linear acceleration and each acceleration, and the first notification condition may be represented including the threshold of the linear acceleration.

In the embodiment described above, the configuration is such that the risk level in the second situation is acquired based on the detection result of the second object sensor 264 and the risk level in the first situation is acquired based on the detection result of the first object sensor 164, however, it is not limited thereto. The risk level may be acquired based on the detection result of at least one of the units included in the first detection unit 143 or the second detection unit 243. For example, the risk level may be calculated based on the accelerations detected by the first acceleration sensor 161 and the second acceleration sensor 261. In particular, the situation of the moving body 2 such as a collision, a sudden start, a sharp turn, sudden braking, or the like in the moving body 2 can be estimated from the change of the acceleration in the moving body 2, and the risk level corresponding to the situation of the moving body 2 can be acquired.

The first processor 110, the second processor 210, and the server processor 310 may be formed of a plurality of processors, or may be formed of a single processor. The first processor 110, the second processor 210, and the server processor 310 may be hardware programmed to realize the functional units described above. In this case, these processors are formed of, for example, an ASIC (application specific integrated circuit) or an FPGA (field programmable gate array).

In addition, the configuration of each unit of the moving body 2, the notification device 1, and the server 3 illustrated in FIG. 2, FIG. 6, and FIG. 7 is an example, and a specific implementation is not limited in particular. That is, hardware individually corresponding to each unit does not need to be mounted, and it is also possible to have the configuration where one processor realizes a function of each unit by executing a program. In addition, some of the functions realized by software in the embodiment described above may be hardware, or some of the functions realized by hardware may be realized by software.

Further, step units of the operations illustrated in FIG. 8, FIG. 9, FIG. 10, and FIG. 12 are divided according to main processing content, and the present invention is not limited by the way of dividing processing units or names thereof. Division into more step units may be performed according to the processing content. In addition, division may be performed such that one step unit includes more processing. Further, an order of the steps may be appropriately changed without obstructing the gist of the present invention.

### 4. Configurations Supported by Embodiment Described Above

The embodiment described above supports the following configurations.

(Configuration 1) A notification system including: a notification device used by a user outside a moving body and provided with a notification device main body; a first notification unit configured to give a notification from the notification device when a first situation including a situation of the user using the notification device and a situation of the notification device main body satisfies a first notification condition; and a second notification unit configured to give a notification from the moving body when a second situation including a situation of the user using the moving body and a situation of the moving body satisfies a second notification condition, wherein the first notification unit, when the first situation satisfies the first notification condition, gives a notification by a notification mode of the second notification unit based on link information in which the first notification condition, the second notification condition, and the notification mode of the second notification unit are linked.

According to the notification system of configuration 1, by linking the first notification condition, the second notification condition, and the notification mode of the second notification unit, the notification matched with the second notification mode in the moving body is given from the notification device, and the user is primed with the notification by the second notification mode in the moving body. Thus, it is possible to improve the degree of the reaction of the user to the notification in the moving body.

(Configuration 2) The notification system according to configuration 1, wherein the second situation is a situation regarding a risk in traffic, and a notification given by the second notification unit is a warning corresponding to the second situation in use of the moving body.

According to the notification system of configuration 2, when the user is not using the moving body, the user is primed with the warning regarding the traffic risk in the moving body. Thus, it is possible to improve the understanding and the acceptability of the user to the warning regarding the traffic risk that is highly important in the moving body.

(Configuration 3) The notification system according to configuration 1 or 2, wherein the second situation is represented by a plurality of elements, the second notification condition is represented including thresholds of the elements, and the first notification condition includes some of the plurality of thresholds in the link information.

According to the notification system of configuration 3, the first notification condition is represented by the thresholds of the elements fewer than the number of the thresholds of the elements of the second notification condition. Thus, even when the situation regarding the moving body and the situation regarding the notification device 1 do not match, if they are similar situations, the user is primed with the notification by the second notification mode in the moving body, and it is possible to improve the degree of the reaction of the user to the notification in the moving body.

(Configuration 4) The notification system according to any one of configurations 1 to 3, wherein the second situation is represented by a plurality of elements, the second notification condition includes thresholds of the elements, and the first notification condition includes a changed value for which at least one of the thresholds is changed in the link information.

According to the notification system of configuration 4, the first notification condition in the first situation of the notification device is represented by the changed value of the threshold of the second notification condition in the second situation of the moving body. Thus, even when the situation regarding the moving body and the situation regarding the notification device 1 do not match, if they are similar situations, the user is primed with the notification by the second notification mode in the moving body, and it is possible to improve the degree of the reaction of the user to the notification in the moving body.

(Configuration 5) The notification system according to any one of configurations 1 to 4, wherein the element is a risk level indicating a level of a risk to the user.

According to the notification system of configuration 5, the second notification condition and the first notification condition are represented by the risk level. Thus, even when the situation regarding the moving body and the situation regarding the notification device 1 do not match, if they are similar situations from the viewpoint of the traffic risk, the user is primed with the notification by the second notification mode in the moving body, and it is possible to improve the degree of the reaction of the user to the notification in the moving body.

(Configuration 6) The notification system according to any one of configurations 1 to 5, including: a first reaction information acquisition unit configured to acquire first reaction information indicating reaction of the user to the notification of the first notification unit; and a notification mode determination unit configured to determine a notification mode of the notification to be given by the first notification unit based on the first reaction information.

According to the notification system of configuration 6, the notification mode is determined according to the reaction of the user to the notification from the notification device. Thus, it is possible to determine the notification mode that is more appropriate from the viewpoint of improving the degree of the reaction of the user.

(Configuration 7) The notification system according to configuration 6, including an instruction unit configured to instruct the first notification unit to give a notification when the reaction information acquisition unit has not acquired a predetermined number or more of pieces of the first reaction information, wherein the notification mode determination unit determines the notification mode of the notification to be given by the first notification unit based on an instruction of the instruction unit.

According to configuration 7, the reaction information corresponding to a specific notification mode is obtained. Thus, since the notification mode is determined based on the reaction information corresponding to various notification modes, it is possible to determine the notification mode that is more appropriate from the viewpoint of improving the degree of the reaction of the user.

(Configuration 8) The notification system according to any one of configurations 1 to 7, including a second reaction information acquisition unit configured to acquire second reaction information indicating reaction of the user to the notification of the second notification unit, wherein the notification mode determination unit further determines the notification mode of the second notification unit based on the second reaction information, and includes an instruction unit configured to instruct, when the notification mode of the second notification unit is changed by the notification mode determination unit, the first notification unit to give a notification by the changed notification mode of the second notification unit.

According to configuration 8, the reaction information corresponding to the specific notification mode is obtained. Thus, since the notification mode is determined based on the reaction information corresponding to various notification modes, it is possible to determine the notification mode that is more appropriate from the viewpoint of improving the degree of the reaction of the user. Further, according to configuration 8, for example, when the reaction of the user to the notification of the second notification unit in the moving body is not appropriate and the notification mode of the second notification unit is changed, the first notification unit gives a notification by the changed notification mode. Thus, it is possible to collect, by the notification from the notification device, the reaction information of the notification mode corresponding to the notification mode in the moving body and to make the notification mode be more appropriate.

(Configuration 9) A notification method including: a first notification step of giving a notification from a notification device when a first situation including a situation of a user using the notification device outside a moving body and a situation of a notification device main body provided in the notification device satisfies a first notification condition; and a second notification step of giving a notification from the moving body when a second situation including a situation of the user using the moving body and a situation of the moving body satisfies a second notification condition, wherein the first notification step, when the first situation satisfies the first notification condition, gives a notification by a notification mode of the second notification step based on link information in which the first notification condition, the second notification condition, and the notification mode of the second notification step are linked.

According to the notification method of configuration 9, effects similar to that of the notification system of configuration 1 are accomplished.

(Configuration 10) A notification device used by a user outside a moving body, the notification device including: a notification device main body; a first notification unit configured to give a notification from the notification device when a first situation including a situation of the user and a situation of the notification device main body satisfies a first notification condition; and a link information acquisition unit configured to acquire link information that links a second notification condition of a second notification unit, that gives a notification from the moving body when a second situation including a situation of the user using the moving body and a situation of the moving body satisfies the second notification condition, with the first notification condition and a notification mode of the second notification unit, wherein the first notification unit, when the first situation satisfies the first notification condition, gives a notification by the notification mode of the second notification unit based on the link information in which the first notification condition, the second notification condition, and the notification mode of the second notification unit are linked.

According to the Notification Device of configuration 10, effects similar to that of the notification system of configuration 1 are accomplished.

(Configuration 11) A non-transitory computer-readable storage medium storing a program that causes a processor of a notification device used by a user outside a moving body and provided with a notification device main body to function as: a first notification unit configured to give a notification from the notification device when a first situation including a situation of the user and a situation of the notification device main body satisfies a first notification condition; and a link information acquisition unit configured to acquire link information that links a second notification condition of a second notification unit, that gives a notification from the moving body when a second situation including a situation of the user using the moving body and a situation of the moving body satisfies the second notification condition, with the first notification condition and a notification mode of the second notification unit, wherein the first notification unit, when the first situation satisfies the first notification condition, gives a notification by the notification mode of the second notification unit based on the link information in which the first notification condition, the second notification condition, and the notification mode of the second notification unit are linked.

According to the program of configuration 11, effects similar to that of the notification system of configuration 1 are accomplished.

### Reference Signs List

1 . . . notification device, 2 . . . moving body, 3 . . . server, 10 . . . link data, 11 . . . notification device main body, 100 . . . first controller, 110 . . . first processor, 111 . . . first situation acquisition unit, 112 . . . first notification unit, 113 . . . first detection result acquisition unit, 114 . . . first reaction information acquisition unit, 115 . . . first communication control unit (link information acquisition unit), 116 . . . collection control unit, 120 . . . first memory, 121 . . . first control program (program), 141 . . . first communication device, 142 . . . first output unit, 143 . . . first detection unit, 151 . . . first sound output unit, 152 . . . first vibration output unit, 153 . . . first heat output unit, 154 . . . first smell output unit, 161 . . . first acceleration sensor, 162 . . . first pressure sensor, 163 . . . first camera, 164 . . . first object sensor, 165 . . . first microphone, 166 . . . first vital sensor, 200 . . . second controller, 210 . . . second processor, 211 . . . second situation acquisition unit, 212 . . . second notification unit, 213 . . . second detection result acquisition unit, 214 . . . second reaction information acquisition unit, 215 . . . second communication control unit (link information acquisition unit, acquisition unit), 220 . . . second memory, 221 . . . second control program, 222 . . . second notification data, 241 . . . second communication device, 242 . . . second output unit, 243 . . . second detection unit, 251 . . . second sound output unit, 252 . . . second vibration output unit, 253 . . . second heat output unit, 254 . . . second smell output unit, 261 . . . second acceleration sensor, 262 . . . second pressure sensor, 263 . . . second camera, 264 . . . second object sensor, 265 . . . second microphone, 266 . . . second vital sensor, 300 . . . server controller, 310 . . . server processor, 311 . . . server communication control unit (acquisition unit), 312 . . . link unit (link information acquisition unit), 313 . . . notification mode determination unit, 320 . . . server memory, 321 . . . server control program, 322 . . . link information DB, 341 . . . server communication device, 1000 . . . notification system, P . . . user, LJ . . . link information, LP . . . threshold setting, LP1 . . . first threshold setting, LP2 . . . second threshold setting.

1. A notification system comprising:
a notification device used by a user outside a moving body and provided with a notification device main body;
a first notification unit configured to give a notification from the notification device when a first situation including a situation of the user using the notification device and a situation of the notification device main body satisfies a first notification condition; and
a second notification unit configured to give a notification from the moving body when a second situation including a situation of the user using the moving body and a situation of the moving body satisfies a second notification condition, wherein
the first notification unit,
when the first situation satisfies the first notification condition,
gives a notification by a notification mode of the second notification unit based on link information in which the first notification condition, the second notification condition, and the notification mode of the second notification unit are linked.

2. The notification system according to claim 1, wherein
the second situation is a situation regarding a risk in traffic, and
a notification given by the second notification unit is a warning corresponding to the second situation in use of the moving body.

3. The notification system according to claim 2, wherein
the second situation is represented by a plurality of elements,
the second notification condition is represented including thresholds of the elements, and
the first notification condition includes some of the plurality of thresholds in the link information.

4. The notification system according to claim 2, wherein
the second situation is represented by a plurality of elements,
the second notification condition includes thresholds of the elements, and
the first notification condition includes a changed value for which at least one of the thresholds is changed in the link information.

5. The notification system according to claim 4, wherein
the element is a risk level indicating a level of a risk to the user.

6. The notification system according to claim 1, comprising:
a first reaction information acquisition unit configured to acquire first reaction information indicating reaction of the user to the notification of the first notification unit; and
a notification mode determination unit configured to determine a notification mode of the notification to be given by the first notification unit based on the first reaction information.

7. The notification system according to claim 6, comprising
an instruction unit configured to instruct the first notification unit to give a notification when the reaction information acquisition unit has not acquired a predetermined number or more of pieces of the first reaction information, wherein
the notification mode determination unit determines the notification mode of the notification to be given by the first notification unit based on an instruction of the instruction unit.

8. The notification system according to claim 6, comprising
a second reaction information acquisition unit configured to acquire second reaction information indicating reaction of the user to the notification of the second notification unit, wherein
the notification mode determination unit further determines the notification mode of the second notification unit based on the second reaction information, and
includes an instruction unit configured to instruct, when the notification mode of the second notification unit is changed by the notification mode determination unit, the first notification unit to give a notification by the changed notification mode of the second notification unit.

9. A notification method comprising:
a first notification step of giving a notification from a notification device when a first situation including a situation of a user using the notification device outside a moving body and a situation of a notification device main body provided in the notification device satisfies a first notification condition; and
a second notification step of giving a notification from the moving body when a second situation including a situation of the user using the moving body and a situation of the moving body satisfies a second notification condition, wherein
the first notification step,
when the first situation satisfies the first notification condition,
gives a notification by a notification mode of the second notification step based on link information in which the first notification condition, the second notification condition, and the notification mode of the second notification step are linked.

10. A notification device used by a user outside a moving body, the notification device comprising:
a notification device main body;
a first notification unit configured to give a notification from the notification device when a first situation including a situation of the user and a situation of the notification device main body satisfies a first notification condition; and
a link information acquisition unit configured to acquire link information that links a second notification condition of a second notification unit, that gives a notification from the moving body when a second situation including a situation of the user using the moving body and a situation of the moving body satisfies the second notification condition, with the first notification condition and a notification mode of the second notification unit, wherein
the first notification unit,
when the first situation satisfies the first notification condition,
gives a notification by the notification mode of the second notification unit based on the link information in which the first notification condition, the second notification condition, and the notification mode of the second notification unit are linked.

11. A non-transitory computer-readable storage medium storing a program that causes a processor of a notification device used by a user outside a moving body and provided with a notification device main body to function as:
a first notification unit configured to give a notification from the notification device when a first situation including a situation of the user and a situation of the notification device main body satisfies a first notification condition; and
a link information acquisition unit configured to acquire link information that links a second notification condition of a second notification unit, that gives a notification from the moving body when a second situation including a situation of the user using the moving body and a situation of the moving body satisfies the second notification condition, with the first notification condition and a notification mode of the second notification unit, wherein
the first notification unit,
when the first situation satisfies the first notification condition,
gives a notification by the notification mode of the second notification unit based on the link information in which the first notification condition, the second notification condition, and the notification mode of the second notification unit are linked.
